(19) United States
(12) Patent Application Publication
(10) Pub. No.: US 2017/0300539 A1
(43) Pub. Date: Oct. 19, 2017

(54) METHOD AND RESULT SUMMARIZING APPARATUS FOR PROVIDING SUMMARY REPORTS OPTIONS ON QUERY RESULTS

(71) Applicant: Huawei Technologies Co., Ltd., Shenzhen (CN)

(72) Inventors: Bhupendra Kumar Jain, Bangalore (IN); Puneet Gupta, Bangalore (IN); Subhadeep Guin, Bangalore (IN)

(21) Appl. No.: 15/640,035

(22) Filed: Jun. 30, 2017

Related U.S. Application Data
(63) Continuation of application No. PCT/CN2015/098704, filed on Dec. 24, 2015.

(30) Foreign Application Priority Data
Jan. 2, 2015 (IN) IN30/CHE/2015

(51) Int. Cl. G06F 17/30

(52) U.S. Cl. CPC G06F 17/30554; G06F 17/3056

(57) ABSTRACT

Embodiment of the present disclosure relates to a method for providing summary reports options on query results. The method is comprises one or more steps performed by a result summarizing apparatus. The first step comprises receiving query results of one or more queries from a query executor by the result summarizing apparatus. The second step comprises receiving group information for each of one or more fields of the query results from a group generating unit by the result summarizing apparatus. The group information comprises data records of each of the one or more fields grouped into one or more groups and each of the one or more groups comprises group record entries. The third step comprises generating summary reports options on the query results using the group information by the result summarizing apparatus. The fourth step comprises providing the summary reports options on the query results to user devices.

### CROSS-REFERENCE TO RELATED APPLICATION

This application is a continuation of International Application No. PCT/CN2015/098704, filed on Dec. 24, 2015, which claims priority to Indian Patent Application IN30/CHE/2015, filed on Jan. 2, 2015. The disclosures of the aforementioned applications are hereby incorporated by reference in their entireties.

### TECHNICAL FIELD OF THE INVENTION

The present disclosure relates to the field of query reports, and in particular, to a method and a result summarizing apparatus for providing summary reports options for query results.

### BACKGROUND

Generally, Big data comprises a collection of large and complex data stored in a Big Data Store (referred as data store). The large and complex data are stored in a form of data blocks which are generally indexed, sorted and compressed. The data store provides efficient tools to explore the data in the data store to provide response to one or more queries specified by a user. An example of such tool is Online Analytical Processing (OLAP) tool to process OLAP based queries requested by the user. Usually, the one or more queries created by the user are executed by a query executor in a query processing server. The query processing server is configured to process the one or more queries using the data or information from the data store. The query executor provides query results which comprises ‘n’ number of data records. Generally, the user does not want to view all the data records and wants to view a summarized report of the query results. Therefore, an aspect of generating summarized query results is carried out to provide only those summarized data relevant to the user.

In one of the conventional methods, the user receives the summarized query results upon selecting preconfigured query analysis templates stored in the query processing server. The preconfigured query analysis templates comprise analysis techniques for analyzing and retrieving information in a summarized form. The preconfigured query analysis templates are created by a secondary developer who may be Information Technology (IT) personnel, Business Intelligence (BI) specialists, data scientists etc. The preconfigured query analysis templates are generated in various query languages which include, but are not limited to, Multidimensional Expressions (MDX) language, Relational Database Management System (RDMS) based language, Structured Query Language (SQL) based language, Not Only Structured Query Language (NoSQL) based language, semi-structured queries based language, and unstructured queries based language. FIG. 1 shows a prior art showing usage of the preconfigured query analysis templates by the user for receiving the query results in summarized form i.e. summary reports of the query results. The secondary developer provides query language specification i.e. type of query language to a report designer. The report designer generates query analysis templates using one or more data sources. The query analysis templates are stored in the query processing server which in turn is provided to the user. The user selects one of the preconfigured query analysis templates to receive the query result in summarized form based on the selected preconfigured query analysis template. The user can interact with the secondary developer for generating a new type of query analysis template. However, an act of generating the preconfigured query analysis templates by the secondary developer is a complex and time consuming process. Also, the user has to request the secondary developer to create a new query analysis template if the user wants to carry out a new type of analysis. Such kind of process consumes time.

Traditionally, a self-service analytics method is provided where the user acts as secondary developer. The user typically selects required fields of the query results in order to view the query results comprising only the selected fields. In case of big data, the query results may contain numerous thousands of data records due to which the user may lose a track of the data records while analyzing. Thus, the user can provide filters and generate one or more summary groups for data of the query results to enhance the analysis. Upon obtaining the data as required by the user, the user selects an appropriate visualization form for viewing the query results. However, the duration to arrive at a final analysis results in the self-service analysis method is more. Also, the existing methods involve manual process of creating the one or more summary reports which are error prone.

### SUMMARY

An objective of the present disclosure is to overcome the disadvantages of the prior arts. The objective of the present disclosure is to eliminate usage of preconfigured analysis templates for providing query results in summarized form. Another objective of the present disclosure is to reduce time consumption for generating summary reports options on query results. Particularly, the objective of the present disclosure is to eliminate manual process of creating the summary of query results.

The present disclosure relates to a method for providing summary reports options on query results. The method is comprises one or more steps performed by a result summarizing apparatus. The first step of the method comprises receiving the query results of one or more queries from a query executor by the result summarizing apparatus. The second step comprises receiving one or more group information for each of one or more fields of the query results from a group generating unit by the result summarizing apparatus. The one or more group information comprises data records of each of the one or more fields grouped into one or more groups and each of the one or more groups comprises group record entries. The third step of the method comprises generating one or more summary reports options on the query results using the one or more group information by the result summarizing apparatus. The fourth step comprises providing the one or more summary reports options on the query results to the one or more user devices.

In an embodiment, the method comprises providing subsequent summary reports options by performing receiving selection of at least one summary reports option among the one or more summary reports options from the one or more user devices. Then, selection of at least one group record entry among the group record entries of the corresponding summary reports option is received from the one or more user devices. Next, one or more subsequent summary reports options of the corresponding summary reports option are generated based on the selection of the at least one group record entry. The one or more subsequent summary reports options generated are provided to the one or more user devices.

A result summarizing apparatus is disclosed in the present disclosure for providing summary reports options on query results. The result summarizing apparatus comprises a receiving module, a summarizing module and an output module. The receiving module is configured to receive the query results of one or more queries from a query executor. The receiving module is configured to receive one or more group information for each of one or more fields of the query results from a group generating unit. The one or more group information comprises data records of each of the one or more fields grouped into one or more groups, and each of the one or more groups comprises the group record entries. The summarizing module is configured to generate one or more summary reports options on the query results using the one or more group information. The output module is configured to provide the one or more summary reports options on the query results to one or more user devices. The summarizing module is further configured to provide subsequent summary reports options.

In an embodiment of the present disclosure, the summarizing module receives selection of at least one summary reports option among the one or more summary reports options from the one or more user devices. Then, the summarizing module receives selection of at least one of a group record entry among the group record entries of the corresponding summary reports option from the one or more user devices. The summarizing module generates one or more subsequent summary reports options of the corresponding summary reports option based on the selection of the at least one group record entry. The output module provides the one or more subsequent summary reports options to the one or more user devices.

The present disclosure relates to a non-transitory computer readable medium including operations stored thereon that when processed by at least one processing unit cause a result summarizing apparatus to perform one or more actions by performing the acts of receiving query results of one or more queries from a query executor. Then, the act of receiving one or more group information for each of one or more fields of the query results from a group generating unit is performed. The one or more group information comprises data records of each of the one or more fields grouped into one or more groups, and each of the one or more groups comprises the group record entries. Next, the act of generating one or more summary reports options on the query results using the one or more group information is performed. Then, the act of providing the one or more summary reports options on the query results to one or more user devices is performed.

The present disclosure relates to a computer program for performing one or more actions on a result summarizing apparatus. The computer program comprises code segment for receiving query results of one or more queries from a query executor; code segment for receiving one or more group information for each of one or more fields of the query results from a group generating unit, wherein The one or more group information comprises data records of each of the one or more fields grouped into one or more groups, and each of the one or more groups comprises the group record entries; code segment for generating one or more summary reports options on the query results using the one or more group information and code segment for providing the one or more summary reports options on the query results to one or more user devices.

In an embodiment, the present disclosure eliminates manual process of generating the summary report options i.e. to generate query results in summarized form, hence, reduction in time consumption for generating summary reports options on query results. In an embodiment, the present disclosure generates summarized query results dynamically and in real-time not restricting to the usage of the preconfigured templates. In an embodiment, the present disclosure provides faster analysis over data store by using the summarized form of the query results, thus, enhance the productivity of the end users. Additionally, the present disclosure summarizes all kinds of reports related to big data which is not performed in the prior arts.

The foregoing summary is illustrative only and is not intended to be in any way limiting. In addition to the illustrative aspects and features described above, further aspects, and features will become apparent by reference to the drawings and the following detailed description.

### BRIEF DESCRIPTION OF THE ACCOMPANYING DRAWINGS

The novel features and characteristic of the present disclosure are set forth in the appended claims. The embodiments of the present invention itself, however, as well as a preferred mode of use, further objectives and advantages thereof, will best be understood by reference to the following detailed description of an illustrative embodiment when read in conjunction with the accompanying drawings. One or more embodiments are now described, by way of example only, with reference to the accompanying drawings.

FIG. 1 show a diagram illustrating usage of the preconfigured query analysis templates by a user for receiving query results in a summarized form in accordance with an embodiment of the prior art;

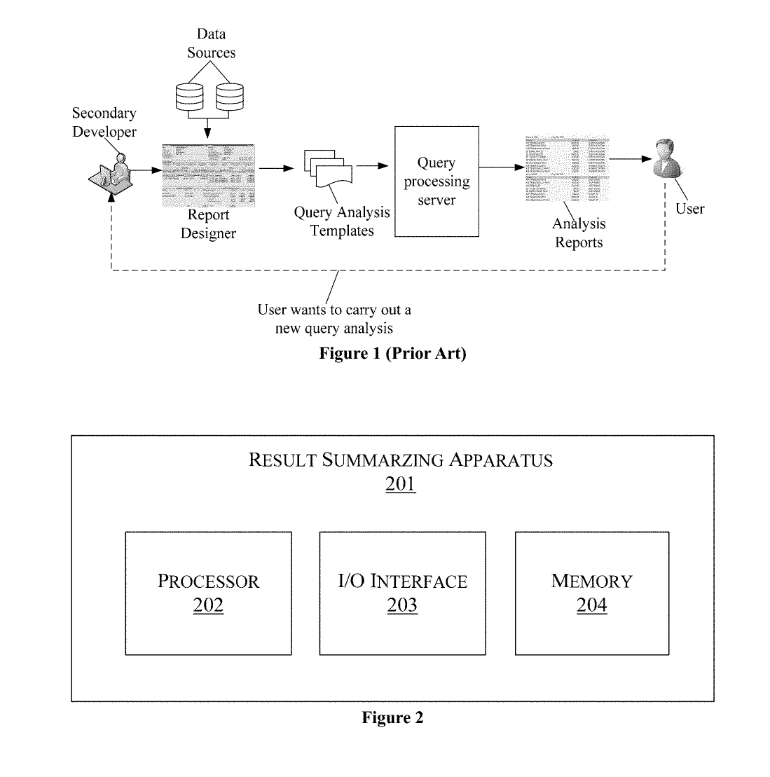

FIG. 2 shows exemplary block diagram illustrating a result summarizing apparatus with processor and memory for providing one or more summary reports options on query results in accordance with some embodiments of the present disclosure;

FIG. 3 shows a detailed block diagram illustrating a result summarizing apparatus with various modules for providing one or more summary reports options on query results in accordance with some embodiments of the present disclosure;

FIG. 4 shows an exemplary diagram illustrating grouping of the data records of each of the one or more fields into the one or more groups in accordance with some embodiments of the present disclosure;

FIGS. 5a-5c show exemplary diagrams illustrating different kinds of grouping process for generating one or more group information in accordance with some embodiments of the present disclosure;

FIG. 6 shows a diagram illustrating one or more summary reports options generated by the summarizing module in accordance with some embodiments of the present disclosure;

FIG. 7 shows a diagram showing one or more subsequent summary reports options generated by summarizing module for a corresponding summary reports option in accordance with some embodiments of the present disclosure;

FIG. 8a illustrates a flowchart of method for providing one or more summary reports options on query results in accordance with some embodiments of the present disclosure;

FIG. 8b illustrates a flowchart of method for generating one or more group information in accordance with some embodiments of the present disclosure;

FIG. 9 illustrates a flowchart of method for providing one or more subsequent summary reports options in accordance with some embodiments of the present disclosure; and

FIG. 10 illustrates a block diagram of an exemplary computer system for implementing embodiments consistent with the present disclosure.

The figures depict embodiments of the present disclosure for purposes of illustration only. One skilled in the art will readily recognize from the following description that alternative embodiments of the structures and methods illustrated herein may be employed without departing from the principles of the present disclosure described herein.

### DETAILED DESCRIPTION

The foregoing has broadly outlined the features and technical advantages of the present disclosure in order that the detailed description of the present disclosure that follows may be better understood. Additional features and advantages of the present disclosure will be described hereinafter which form the subject of the claims of the invention. It should be appreciated by those skilled in the art that the conception and specific aspect disclosed may be readily utilized as a basis for modifying or designing other structures for carrying out the same purposes of the present disclosure. It should also be realized by those skilled in the art that such equivalent constructions do not depart from the scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

Embodiments of the present disclosure relates to providing summary reports options on query results. In an embodiment, the query results of one or more queries are received from a query executor. That is, the one or more queries created by a user using the one or more user devices are executed by the query executor in a traditional manner. More particularly, the query executor executes the one or more queries in a data store or database based on tuple and/or constraints of the one or more queries. The query executor accesses or retrieves query results comprising data records pertaining to the one or more queries from the data store in a traditional form. The data store is a storage device storing big data. The query results retrieved by the query executor are received by the result summarizing apparatus. The result summarizing apparatus determines factors which include, but are not limited to, result data of the query results, metadata of the one or more queries and context of the one or more queries from the query results. The result summarizing apparatus provides the factors to a group generating unit. The group generating unit generates group information using the factors. The group information comprises data records of each of one or more fields of the query results grouped into one or more groups. Each of the one or more groups comprises group record entries which are sets of the data records. The result summarizing apparatus generates summary reports options on the query results using the group information. The summary reports options on the query results comprises summarized data records of the query results. The summary reports options are provided to the one or more user devices for viewing. Further, one or more subsequent summary reports options for a corresponding summary reports option is provided. The result summarizing apparatus receives selection of at least one summary reports option from the one or more user devices. Then, the result summarizing apparatus receives selection of at least one group record entry of the corresponding summary reports option from the one or more user devices. Then, subsequent summary reports options of the corresponding summary reports options are generated by using the group information on the selected group record entry. The subsequent summary reports options are provided to the one or more user devices. In this way, the user is facilitated with analyzing the query results in summarized form with various multiple summary reports options.

Henceforth, embodiments of the present disclosure are explained with the help of exemplary diagrams and one or more examples. However, such exemplary diagrams and examples are provided for the illustration purpose for better understanding of the present disclosure and should not be construed as limitation on scope of the present disclosure.

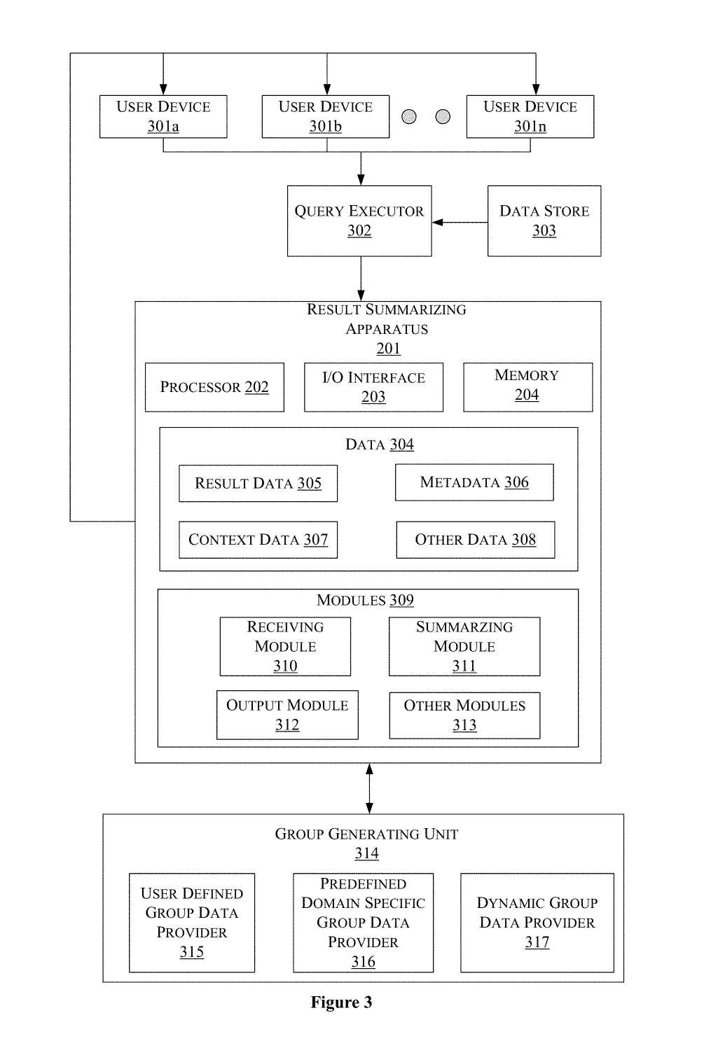

FIG. 2 shows exemplary block diagram illustrating a result summarizing apparatus 201 with processor 202 and memory 204 for providing one or more summary reports options on query results in accordance with some embodiments of the present disclosure. The result summarizing apparatus 201 comprises the processor 202, Input/Output (I/O) interface 203 and the memory 204. The memory 204 is communicatively coupled to the processor 202. The memory 204 stores processor-executable instructions which on execution cause the processor 202 to perform one or more steps. The processor 202 receives the query results of one or more queries from a query executor (not shown in FIG. 2). Then, the processor 202 receives one or more group information for each of one or more fields of the query results from a group generating unit. In an embodiment, the one or more group information comprises data records of each of the one or more fields grouped into one or more groups, and each of the one or more groups comprises group record entries. The processor 202 generates one or more summary reports options on the query results using the one or more group information. The processor 202 provides the one or more summary reports options on the query results to one or more user devices. The processor 202 is further configured to provide subsequent summary reports options. The processor 202 receives selection of at least one summary reports option among the one or more summary reports options from the one or more user devices. Then, the processor 202 receives selection of at least one of a group record entry among the group record entries of the corresponding summary reports option from the one or more user devices. The processor 202 generates one or more subsequent summary reports options of the corresponding summary reports option based on the selection of the at least one group record entry. The processor 202 provides the one or more subsequent summary reports options to the one or more user devices.

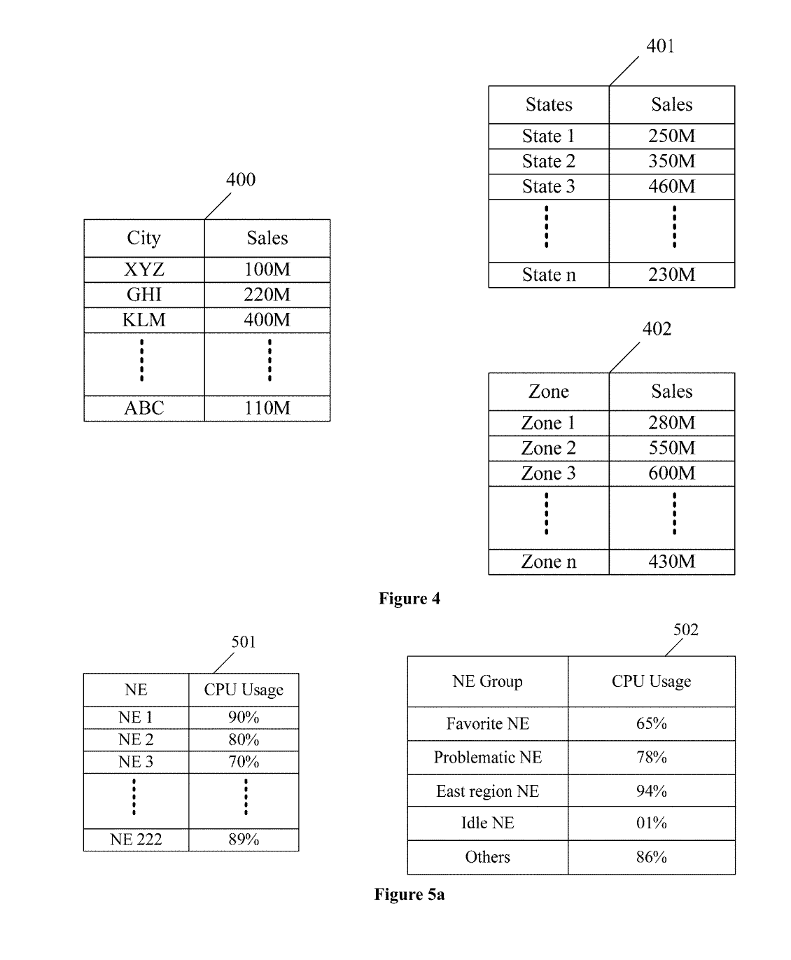

FIG. 3 shows a detailed block diagram illustrating the result summarizing apparatus 201 with various modules for providing one or more summary reports options on query results in accordance with some embodiments of the present disclosure.

In one implementation, the result summarizing disclosure 201 may be implemented in a variety of computing systems, such as a laptop computer, a desktop computer, a notebook, a workstation, a mainframe computer, a server, a network server, and the like. In an embodiment, the result summarizing apparatus 201 is communicatively connected to one or more user devices 301a, 301b, . . . , 301n (collectively referred to 301), a query executor 302 and a group generating unit 314.

In one implementation, the query executor 302 is configured to execute one or more queries created by a user. In an embodiment, the one or more queries include, but are not limited to, Multidimensional Expressions (MDX) based queries, Relational Database Management System (RDMS) based queries, Structured Query Language (SQL) based queries, Not Only Structured Query Language (NoSQL) based queries, semi-structured queries based queries, and unstructured queries based queries. The user creates the one or more queries by using the one or more user devices 301. Examples of the one or more user devices 301 include, but are not limited to, a desktop computer, a portable computer, a mobile phone, a handheld device, a workstation. The one or more user devices 301 may be used by various stakeholders, Information Technology (IT) personnel, Business Intelligence (BI) specialists, data scientists or end users of an organization.

In one implementation, the one or more user devices 301 display one or more summary reports options provided by the result summarizing apparatus 201. In an embodiment, the users are enabled to interact with the one or more summary reports through the user interface (not shown in FIG. 3) of the one or more user devices 301 to update the one or more queries. The user interface is an interactive graphical user interface of the one or more user devices 301. The user interaction is facilitated using input device (not shown in FIG. 3) including, but not limiting to, stylus, finger, pen shaped pointing device, keypad and any other device that can be used to input through the user interface. The users may include a person, a person using the one or more user devices 301 such as those included in this present disclosure, or such a user device itself. In an embodiment, the user updates the one or more queries to view one or more subsequent summary reports options of a corresponding summary reports option among the one or more summary reports options. In an embodiment, the result summarizing apparatus 201 provides the one or more subsequent summary reports options to the one or more user devices 301 upon receiving the one or more updated queries from the one or more user devices 301.

In one implementation, the one or more queries created by the user by using the one or more user devices are received by query executor 302. The query executor 302 is communicatively connected to the one or more user devices 301 through a first network (not shown in FIG. 3). The query executor 302 receives the one or more queries created by the user through the first network. The query executor is connected to a data store 303 through a second network (not shown in FIG. 3) for executing the one or more queries. In an embodiment, the query executor 302 executes the one or more queries in the data store 303 using traditional methods and/or existing methods. A person skilled in the art should understand any kind of traditional methods can be performed for executing the one or more queries in the data store 303.

The data store 303 stores big data information. The information stored in the data store 303 may be related to one or more establishments, including, but are not limited to, financial institutions, stocks, commercial establishments, government offices, data security centers, social networks, educational institutions, weather forecast centers and manufacturing industries. For example, data store 303 stores information relating to mobile subscribers, model name of the mobile device i.e. mobile phone, subscribing data, traffic usage of a subscribing network, bandwidth provided by the subscribed plan, International Mobile Equipment Identity (IMEI) details, brand name of the mobile device, and subscribed plan details etc. which falls under commercial establishments. In an exemplary embodiment, information of one or more establishments are stored in the data store 303 in predefined format or structures or extensions, such as but are not limiting to, a flat file, a hierarchical on-line analytical processing data cube, a multidimensional cubes, a relational data store, an on-line analytical processing (OLAP) data cube and an Excel file. A person skilled in the art should understand that there can be any number of data stores that stores big data information.

In an embodiment, the query executor 302 receives query results pertaining to the one or more queries from the data store 303. For example, consider the query specified by the user requires retrieving ‘subscribers’ and ‘traffic usage’ of the subscribed plan opted by the subscribers. Table 1 shows the query results retrieved for the query specifying ‘subscriber’ and ‘traffic usage’ as fields of the subscribed plan.

TABLE 1

| Subscriber | Traffic Usage |
|---|---|
| S-1 | 100 GB |
| S-2 | 200 GB |
| S-3 | 400 GB |
| . | . |
| . | . |
| . | . |
| S-n | 200 GB |

Table 1 shows the query results having ‘n’ number of ‘subscribers’ with ‘corresponding traffic usage values pertaining to field ‘traffic usage’. For example, the subscriber ‘S-1’ has traffic usage of 100 Gigabit (GB), subscriber ‘S-2’ has traffic usage of 200 GB and so on.

Another example, consider the query specified by the user requires retrieving ‘sales’ information of the telecom domain in different regions of the country. Table 2 shows the query results retrieved for the query with ‘city’ and ‘sales’ as fields of the telecom domain.

TABLE 2

| City | Sales |
|---|---|
| XYZ | 100M |
| GHI | 220M |
| KLM | 400M |
| . | . |
| . | . |
| . | . |
| ABC | 110M |

Table 2 shows sales information of different regions i.e. cities. For example, the city ‘XYZ’ has sales of 100 Million (M). The city ‘GHI’ has sales of 220 M and so on.

Usually, the query results received from the data store 303 by the query executor 302 comprises one or more fields, where each field has ‘n’ number of data records. For example, referring to Table 2, ‘XYZ’ is one data record of field ‘city’ and ‘GHI’ is one data record of field ‘city’ and so on. The sale information of ‘100 M’ is one data record of field ‘sales’ corresponding to data record ‘XYZ’ of field ‘city’ and ‘220 M’ is one data record of field ‘sales’ corresponding to data record ‘GHI’ of field ‘city’ and so on. A person skilled in art should understand that any number of fields can be included in the query results based on the user generated query. In an embodiment, the query results received by the query executor 302 may be cached into a cache memory (not shown in FIG. 3) connected to the query executor 302. In an embodiment, the query results can be cached into a cache memory (not shown in FIG. 3) of the query executor 302.

In an embodiment, the query executor 302 is connected to the result summarizing apparatus 201 through a third network (not shown in FIG. 3). The query executor 302 provides the query results to the result summarizing apparatus 201 for generating one or more summary reports options on the query results. The result summarizing apparatus 201 summarizes the query results to provide only those set of data records of the query results which are of relevance to the requirement of the one or more queries. For example, the query results may contain millions of data records. However, the user may require only top fifty records to be displayed. Therefore, the one or more summary reports options are generated providing a view of only top fifty records of the query results as per the requirements of the user. The one or more summary reports options are provided in order to enhance the process of analyzing of the big data and reduce the analysis time towards the queries. Also, the one or more summary reports options on the query results are provided in order to provide query results depending upon a size of a user interface of the one or more user devices associated to the user. For example, millions of data records cannot be displayed together on the mobile phone. Therefore, the one or more summary reports of 20 data records grouped together can be displayed on the mobile phone. Additionally, in an embodiment, the one or more summary reports options are partial results of data records of the query results which can reduce a load on the data store by providing only those query results required by the user.

In one implementation, the result summarizing apparatus 201 includes a central processing unit (“CPU” or the “processor”) 202, the input/output (I/O) interface 203 and the memory 204. The processor 202 of the result summarizing apparatus 201 may comprise at least one data processor for executing program components and for generating the one or more summary reports options. Among other capabilities, the processor 202 is configured to fetch and execute computer-readable instructions stored in the memory 204. The I/O interface 203 is coupled with the processor 202 and an I/O device (not shown). The I/O device is configured to receive the query results from the query executor 302 via the I/O interface 203. The I/O interface 203 transmits outputs or results i.e. the one or more summary reports options and the one or more subsequent summary reports options for displaying in the I/O device via the interface 203.

In one implementation, the memory 204 is communicatively coupled to the processor 202. The memory 204 stores processor-executable instructions to provide the one or more summary reports options. The memory 204 may store information which include, but is not limited to, result data of the query results, metadata of the one or more queries and context of the one or more queries, one or more group information received from the group generating unit 314, the one or more summary reports options generated on the query results, the one or more subsequent reports options of the corresponding summary reports option, query results of previous queries, the user profile generating the one or more queries and size of the user interface of the one or more user devices 301.

In an embodiment, the result summarizing apparatus 201 receives data 304 relating to the query results from query executor 302. In one example, the data 304 received from the query executor 302 may be stored within the memory 204. In one implementation, the data 304 may include, for example, result data 305, metadata 306, context data 307 and other data 308.

The result data 305 is the data relating the data records present in the query results as specified by the one or more queries. The metadata 306 is the information relating to data required by the one or more queries. In an embodiment, the metadata 306 comprises name of the field, type of the field and description of the field. For example, the field named “year” indicates time field and type of field is ‘year’. The context data 307 refers to a context specified in the one or more queries. For example, considering the one or more queries specifies to retrieve query results relating to subscriber's plans of a mobile network. In such case, the context of the one or more queries refers to the telecom area. Also, the context data 307 may refer to profile information of the user and/or the size of the user interface of the one or more user devices 301 used by the user.

In one embodiment, the data 304 may be stored in the memory 204 in the form of various data structures. Additionally, the aforementioned data 304 may be organized using data models, such as relational or hierarchical data models. The other data 308 may be used to store data, including temporary data and temporary files, generated by the modules 309 for performing the various functions of the result summarizing apparatus 201. In an embodiment, the data 304 are processed by modules 309 of the result summarizing apparatus 201. The modules 309 may be stored within the memory 204.

The modules 309 may include, for example, a receiving module 310, a summarizing module 311, and an output module 312. The result summarizing apparatus 201 may also comprise other modules 313 to perform various miscellaneous functionalities of the result summarizing apparatus 201. It will be appreciated that such aforementioned modules may be represented as a single module or a combination of different modules.

In one implementation, the receiving module 310 is configured to receive the query results from the query executor 302. In an embodiment, the receiving module 310 receives the result data 305 of the query results, metadata 306 of the one or more queries and context data 307 of the one or more queries from the query executor 302. In one implementation, the result summarizing apparatus 201 provides the result data of the query results, metadata and context of the one or more queries to the group generating unit 314. In an embodiment, the result summarizing apparatus 201 is connected the group generating unit 314 through a fourth network (not shown in FIG. 3). The group generating unit 314 is configured to generate one or more group information based on the result data of the query results, metadata and context of the one or more queries. In an embodiment, the one or more group information comprises data records of each of one or more fields of the query results grouped into one or more groups.

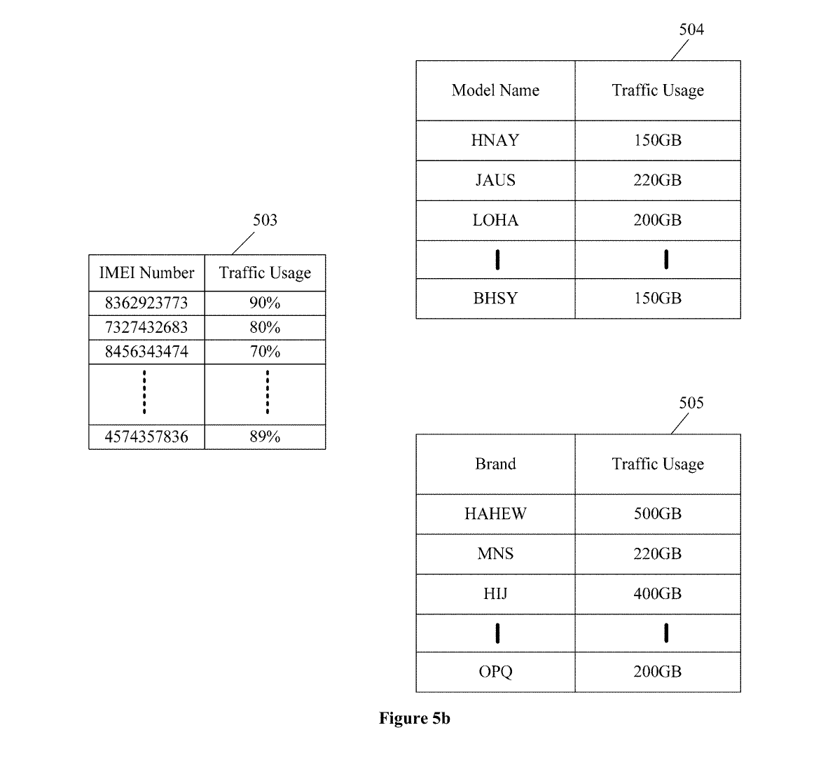

FIG. 4 shows an exemplary diagram illustrating grouping of the data records of each of the one or more fields into the one or more groups in accordance with some embodiments of the present disclosure. In the illustrative FIG. 4, data records of each field of query result referred by 400 is grouped into the one or more groups. Particularly, the data records of the field ‘city’ are grouped into the one or more groups, for example state group as referred by 401 and zone group as referred by 402. For example, the city ‘XYZ’ and the city GHI′ of field ‘city’ are grouped into one state group which groups the cities state-wise. Another example, the city ‘XYZ’, the city ‘GHI’ and the city ‘KLM’ of field ‘city’ are grouped into one zone group as referred by 402 which groups the cities zone-wise. That is, the city ‘XYZ’, the city ‘GHI’ and the city ‘KLM’ of field ‘city’ are grouped into ‘Zone 1’ of the field ‘Zone’.

In an embodiment, each of the one or more groups of the group information comprises group record entries. The group record entries comprise the group of data records of the corresponding field. For example, referring to FIG. 4, the group ‘State’ comprises group records entries namely ‘State 1’, State 2, ‘State 3’ and so on.

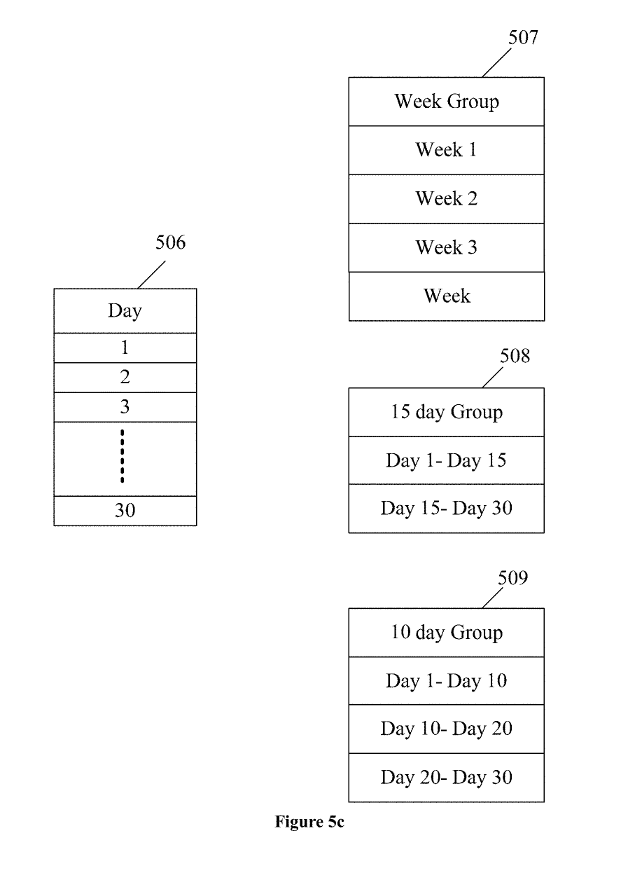

In an embodiment, the group generating unit 314 comprises user defined group data provider 315, predefined domain specific group data provider 316 and dynamic group data provider 317. The user defined group data provider 315 comprises user-defined group information. The predefined domain specific group data provider 316 comprises group information based on domain specific defined in the fields of the query results and the dynamic group data provider 317 comprises dynamically generated group information. The user-defined group information refers to the one or more group information which are defined by the user. FIG. 5a shows an exemplary diagram illustrating grouping of data records of the query results based on user-defined group information. For example, consider the user defines the one or more group information to be generated based on preferences as required by the user. In an embodiment, the one or more group information can be configured by a system administrator for a group of user. For example, considering the query results comprising Network Element (NE) data under field ‘NE’ with corresponding amount of CPU used. For example, NE 1 has CPU usage of 90%, NE 2 has CPU usage of 80% and so on. The user groups the NE data into one or more groups namely ‘Favorite NE’, ‘Problematic NE’, ‘East region NE’, ‘Idle NE’ and puts rest NE data in ‘others’ as referred by 502. The amount of CPU usage is updated based on grouping of the NE data into various groups. That is, the group ‘Favorite NE’ has CPU usage of 85%, the group ‘Problematic NE’ has CPU usage of 78% and so on as referred by 502.

In an embodiment, the domain specific group information defined in the fields of the query results refers to the one or more group information which are generated based on specific domain of the query results. Such group information uses domain specific data which are identified from the information of the one or more fields. The group generating unit 314 groups the data records of each of the one or more fields into one or more groups using the domain specific data. For example, considering the query results received from the query executor 302 comprises only International Mobile Equipment Identity (IMEI) data. From the IMEI field, the group generating unit 314 identifies that the domain of the IMEI is related to telecom establishment. Hence, the group generating module 314 groups the IMEI data into groups namely ‘Model Type’ and ‘Brand’ based on the domain specific data which is identified from the information of the one or more fields. FIG. 5b shows an exemplary diagram showing one or more groups of IMEI data based on the domain specific data. From the illustrative FIG. 5b, the query results are depicted by numeral 503 comprising various IMEI numbers. The IMEI data is grouped into a group named ‘Model Type’ as depicted by 504 having group records entries namely ‘HNAY, ‘JAUS’, ‘LOHA’ and so on. The IMEI data is grouped into a group named ‘Brand’ depicted by 505 having group record entries namely ‘HAHEW’, ‘MNS’ and so on.

In an embodiment, the dynamically generated group information refers to group information which are created dynamically by the group generating unit 314 based on the one or more fields. Usually, ‘Time’ field and ‘Date’ field are commonly used in analyzing the query results. Therefore, the group generating unit 314 dynamically groups ‘Time’ field into groups namely ‘Week Group’, ‘Month Group’, ‘Year group’, ‘15 days group’, ‘Quarter Group’, ‘% year Group’ and the like. FIG. 5c shows a diagram illustrating grouping the day level data into multiple groups. For example, considering the query results comprises day based data records depicted by 506. The group generating unit 314 groups the day based data records into groups namely ‘Week Group’ depicted as 507, ‘15 day Group’ depicted as 508 and ‘10 day Group’ depicted as 509.

The summarizing module 311 of the result summarizing apparatus 201 uses the one or more group information from the group generating unit 314 for generating one or more summary reports options on the query results. In an embodiment, the summarizing module 311 generates the one or more summary reports options based on factors which include, but are not limited to, size of the query results, measure values of the query results, dimensions of the query results, the user-defined group information 315, group information created using domain specific information 316, group information defined dynamically by the group generating unit based on the one or more fields 317, query results of previous queries, information of the user generating the one or more queries and size of a user interface of the one or more user devices.

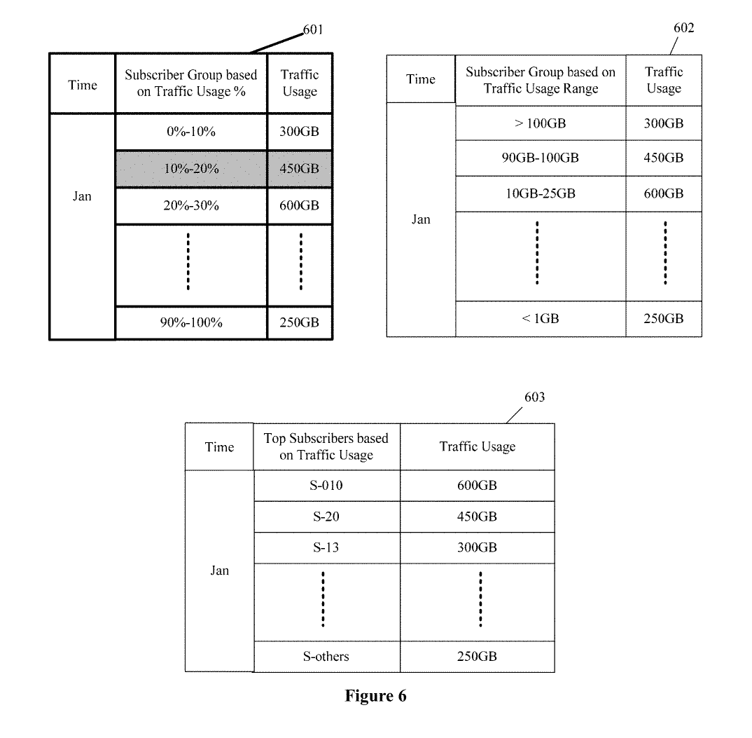

FIG. 6 shows a diagram illustrating the one or more summary reports options generated by the summarizing module 311. For example, considering the user wants to obtain details of top 100 subscribers based on traffic usage. The user drag the fields named “subscriber” and “traffic usage” and drop the fields in the query specifying area or box. The query is received by the query executor 302 which executes the query in the data store 303. Based on the query execution, the query executor 302 provides query results containing millions of records for the subscribers along with details of their traffic usage. The query results are received by the result summarizing apparatus 201. The summarizing module 311 generates the one or more summary reports options 601, 602 and 603 for the query results as illustrated by FIG. 6. In an embodiment, the summary reports options are generated in order to enhance the process of analyzing of the big data and reduce the analysis time towards the queries. Additionally, in an embodiment, the summary reports options are partial results of data records on the query results which can reduce a load on the data store by providing only those query results required by the user. Also, the summary reports options for the query results are provided in order to provide query results depending upon a size of a user interface of the one or more user devices associated to the user. In an example, each of the one or more summary reports options contains the details of the summarized reports for the subscribers along with their traffic usage. The summary reports option 601 shows the subscriber group generated based on traffic usage percentage (%). For example, 0%-10% subscribers have traffic usage of 300 GB and 10%-20% subscribers have traffic usage of 450 GB and so on. The summary reports option 602 shows subscribers grouped based on a range of the traffic usage. For example, the subscribers using the bandwidth greater than 100 GB has the traffic usage of 300 GB, subscribers using the bandwidth of the range from 90 GB to 100 GB has the traffic usage of 450 GB and so on. The summary reports option 603 shows the top subscribers group generated based on the traffic usage. For example, subscriber S-010 has traffic usage of 600 GB and S-20 has traffic usage of 450 GB and so on. In an embodiment, each of the one or more summary reports option 601, 602 and 603 comprises the group record entries.

The output module 312 provides the generated one or more summary reports options 601, 602 and 603 to the one or more user devices 301. The one or more summary reports options 601, 602 and 603 are displayed on the user interface of the one or more user devices 301 for user interaction. In this way, the user can view the details of top 100 subscribers in different summarized forms. The user can interact with the one or more summary reports options 601, 602 and 603 for receiving one or more subsequent summary reports options.

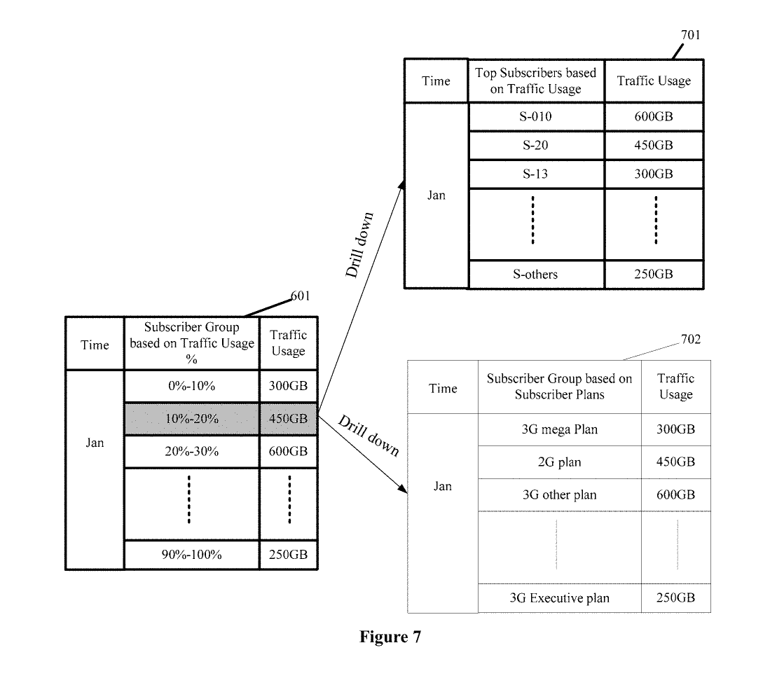

In an embodiment, the summarizing module 311 generates one or more subsequent reports options based upon user interaction. For generating the one or more subsequent summary reports options, the user selects at least one summary reports option among the one or more summary report options. Then, the user selects at least one group record entry among the group record entries. In an embodiment, the group record entries are the data entries in the column of the table of the corresponding summary report options. For example, the subscribers using the bandwidth greater than 100 GB having the traffic usage of 300 GB is one group record entry. The subscribers using the bandwidth of the range from 90 GB to 100 GB having the traffic usage of 450 GB is second group record entry and so on. The summarizing module 311 receives selection of the at least one summary report option followed by the selection of the at least one group record entry. Based on the selection of the at least group record entry, the summarizing module 311 generates the one or more subsequent summary reports options which are provided to the one or more user devices 301. In an embodiment, the selection of the group record entry is processed as a filter for further analysis of the query result which is in turn used to generate the one or more subsequent reports options. FIG. 7 shows a diagram showing one or more subsequent reports options generated by the summarizing module 311 for a corresponding summary reports option. For example, considering the user wants to view top subscribers under 10% to 20% of subscriber group. Then, the user selects the summary reports option 601 among the one or more summary reports option 601, 602 and 603. For example, the user selects group record entry ‘10%-20%’ group record entry from the summary report option 601. Then, the summarizing module 311 generates the one or more subsequent summary reports options numbered 701 and 702 for the selected group record entry ‘10%-20%’. The generated one or more subsequent summary reports options 701 and 702 are provided to the user interface of the one or more user devices 301 for user interaction. The user selects the subsequent summary report option 701 to view the top subscribers based on the traffic usage. In an embodiment, the one or more subsequent summary reports options are generated based on the factors listed in above paragraph.

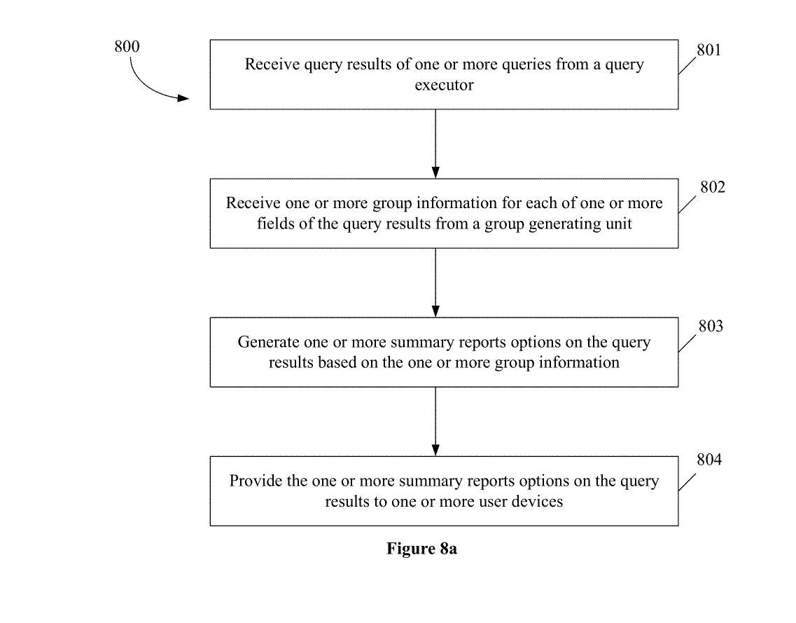

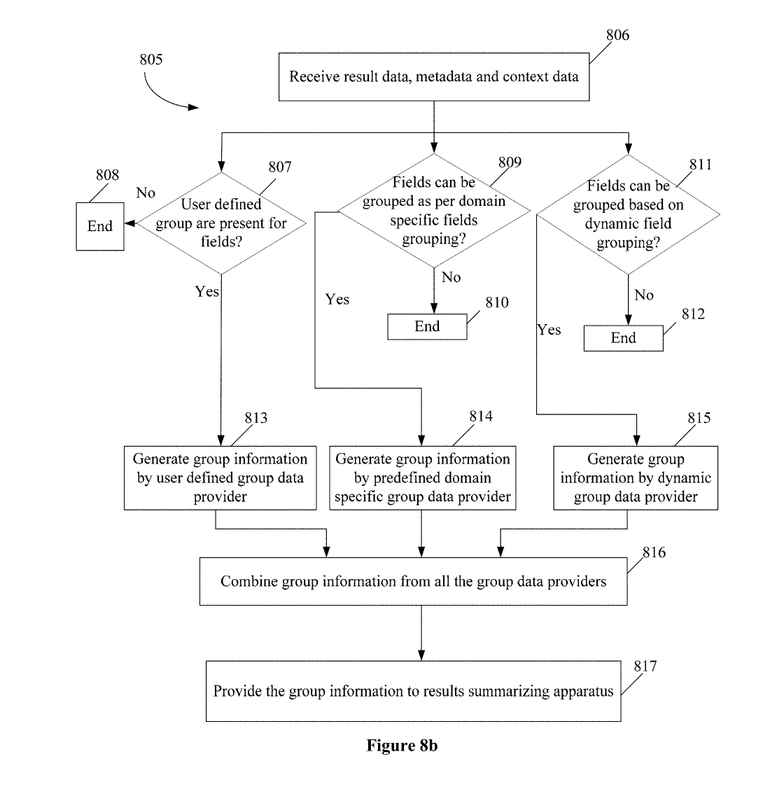

As illustrated in FIGS. 8 (a and b), and 9, the methods 800, 805 and 900 comprises one or more blocks for providing one or more summary reports options by the result summarizing apparatus 201. The methods 800, 805 and 900 may be described in the general context of computer executable instructions. Generally, computer executable instructions can include routines, programs, objects, components, data structures, procedures, modules, and functions, which perform particular functions or implement particular abstract data types.

The order in which the he methods 800, 805 and 900 are described is not intended to be construed as a limitation, and any number of the described method blocks can be combined in any order to implement the methods 800, 805 and 900. Additionally, individual blocks may be deleted from the he methods 800, 805 and 900 without departing from the spirit and scope of the subject matter described herein. Furthermore, the he methods 800, 805 and 900 can be implemented in any suitable hardware, software, firmware, or combination thereof.

FIG. 8a illustrates a flowchart of method 800 for providing the one or more summary reports options on the query results in accordance with some embodiments of the present disclosure.

At block 801, the receiving module 310 receives the query results of the one or more queries from the query executor 302. In an embodiment, the query results of the one or more queries are retrieved from the data store 303 by the query executor 302. The query results comprising result data of the query results, metadata of the one or more queries and the context of the one or more queries are provided to the group generating module 314 by the result summarizing apparatus 201.

At block 802, the receiving module 310 receives the one or more group information for each of the one or more fields of the query results from the group generating unit 314. In an embodiment, the group generating unit 314 generates the one or more group information for each of the one or more fields of the query results. The one or more group information are generated based on the result data of the query results, metadata of the one or more queries and the context of the one or more queries The one or more group information include, but is not limited to, user-defined group information, group information created using information of the one or more fields and group information defined dynamically by the group generating unit based on the one or more fields. The generation of the one or more group information by the group generating unit 314 is illustrated in FIG. 8b.

At block 803, the summarizing module 311 generates the one or more summary reports options on the query results using the one or more group information. In an embodiment, the one or more summary reports options are generated based on factors which include, but are not limited to, size of the query results, measure values of the query results, dimensions of the query results, the user-defined group information, group information created using information of the one or more fields, group information defined dynamically by the group generating unit based on the one or more fields, query results of previous queries, the user raising the one or more queries and size of a user interface of the one or more user devices.

At block 804, the one or more summary reports options are provided to the user devices 301 for display by the output module 312.

FIG. 8b illustrates a flowchart of method 805 for generating the one or more group information by the group generating unit 314 in accordance with some embodiments of the present disclosure.

At block 806, the group generating unit 314 receives the result data of the query results, metadata and context data of the one or more queries from the result summarizing apparatus 201.

A field metadata selector (not shown) determines grouping of the fields of the query results comprising the result data, metadata and the context data by the group generating unit 314.

At block 807, the field metadata selector determines whether the user defined groups are present for the fields of the query results. If the user defined groups are present for the fields in the query results, then the process goes to block 813 via “Yes”. At block 813, the user defined group data provider 315 generates one or more group information based on user defined grouping. If the user defined groups are not present for the fields in the query results, then the process is ended at block 808 via ‘No’.

At block 809, the field metadata selector determines whether the fields of the query results can be grouped as per domain specific fields grouping. If the fields can be grouped as per domain specific group information, then the process goes to block 814 via “Yes”. At block 814, the predefined domain specific group data provider 316 generates one or more group information based on domain specific group information. In the alternative, if the fields cannot be grouped as per domain specific fields grouping, then the process is ended at block 810 via ‘No’.

At block 811, the field metadata selector determines whether the fields of the query results can be grouped based on dynamic field grouping information. If the fields can be groped based on dynamic field grouping information, then the process goes to block 815 via “Yes”. At block 815, the dynamic group data provider 317 generates one or more group information based on dynamic field group information. In the alternative, if the fields cannot be grouped based on dynamic field grouping information, then the process is ended at block 812 via ‘No’.

At block 816, the one or more group information from each of the user defined group data provider 315, the predefined domain specific group data provider 316 and the dynamic group data provider 317 are combined by the group generating unit 314.

At block 817, the combined group information is provided to the result summarizing apparatus 201 to create one or more summary reports options.

In an embodiment, the one or more summary reports options are provided based on the size of the user interface of the one or more user devices 301. For example, the one or more summary reports options with 10 data records can be provided when the user device 301 is mobile phone. The one or more summary reports options with 500 data records can be provided when the user device 301 is computer desktop.

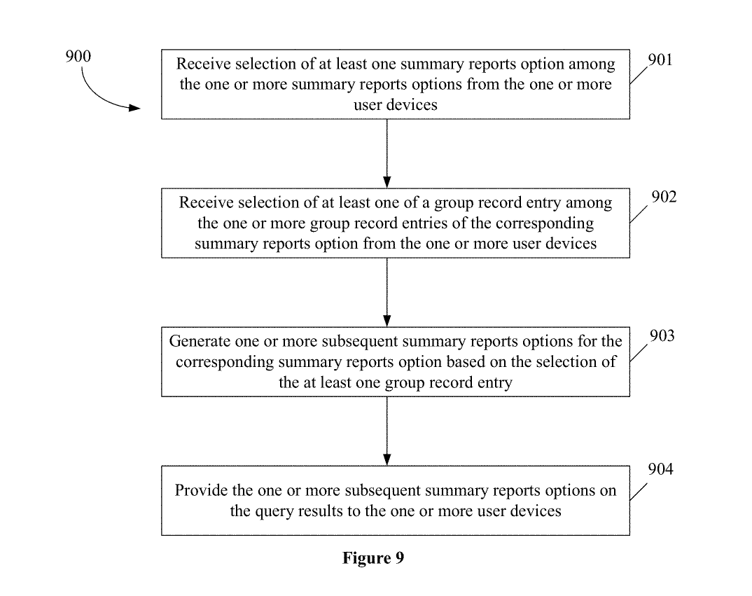

FIG. 9 illustrates a flowchart of method 900 for providing the one or more subsequent summary reports options in accordance with some embodiments of the present disclosure.

At block 901, the summarizing module 311 receives the selection of at least one summary reports option among the one or more summary reports options from the one or more user devices 301.

At block 902, the summarizing module 311 receives the selection of at least one group record entry among the group record entries from the one or more user devices 301.

At block 903, the summarizing module 311 generates the one or more subsequent summary reports options of the corresponding summary reports option based on the selection of the at least one group record entry. In an embodiment, the one or more subsequent summary reports options are generated based on factors which include, but are not limited to, size of the query results, measure values of the query results, dimensions of the query results, the user-defined group information, group information created using information of the one or more fields, group information defined dynamically by the group generating unit based on the one or more fields, query results of previous queries, the user raising the one or more queries and size of a user interface of the one or more user devices.

At block 904, the one or more subsequent summary reports options are provided to the user devices for display by the output module 312.

### Computer System

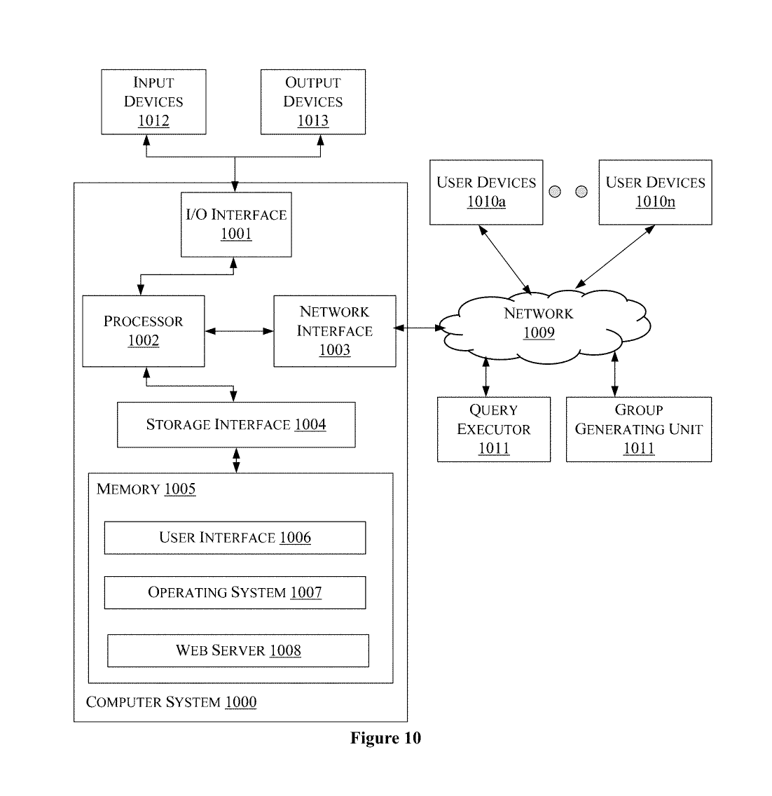

FIG. 10 illustrates a block diagram of an exemplary computer system 1000 for implementing embodiments consistent with the present disclosure. In an embodiment, the computer system 1000 is used to implement the result summarizing apparatus 201. The computer system 1000 may comprise a central processing unit (“CPU” or “processor”) 1002. The processor 1002 may comprise at least one data processor for executing program components for providing one or more summary reports options on the query results. The processor 1002 may include specialized processing units such as integrated system (bus) controllers, memory management control units, floating point units, graphics processing units, digital signal processing units, etc.

The processor 1002 may be disposed in communication with one or more input/output (I/O) devices (1012 and 1013) via I/O interface 1001. The I/O interface 1001 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

The I/O interface(s) 1001 may include a variety of software and hardware interfaces, for example, a web interface, a graphical user interface, etc. Using the I/O interface 1001, the computer system 1000 may communicate with one or more I/O devices (1012 and 1013). For example, the input device 1012 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, etc. The output device 1013 may be a printer, fax machine, video display (e.g., cathode ray tube (CRT), liquid crystal display (LCD), light-emitting diode (LED), plasma, or the like), audio speaker, etc.

In some embodiments, the processor 1002 may be disposed in communication with a communication network 1009 via a network interface 1003. The network interface 1003 may communicate with the communication network 1009. In an embodiment, the communication network 1009 includes the first network, the second network, the third network and the fourth network. The network interface 1003 may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 1009 may include, without limitation, a direct interconnection, local area network (LAN), wide area network (WAN), wireless network (e.g., using Wireless Application Protocol), the Internet, etc. Using the network interface 1003 and the communication network 1009, the computer system 1000 may communicate with one or more user devices 1010 (a, . . . , n). The one or more user devices 1010 (a, . . . , n) may include, without limitation, personal computer(s), server(s), fax machines, printers, scanners, various mobile devices such as cellular telephones, smartphones, tablet computers, eBook readers, laptop computers, notebooks, gaming consoles, or the like. In an embodiment, one or more queries is received from the one or more user devices 1010 (a, . . . , n) which may be used by various stakeholders, Information Technology (IT) administrators, business analyst, software tester, software developer or end users of an organization.

In some embodiments, the processor 1002 may be disposed in communication with a memory 1005 (e.g., RAM, ROM, etc. not shown in FIG. 10) via a storage interface 1004. The storage interface 1004 may connect to memory 1005 including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

The memory 1005 may store a collection of program or database components, including, without limitation, user interface application 1006, an operating system 1007, web server 1008 etc. In some embodiments, computer system 1000 may store user/application data 1006, such as the data, variables, records, etc. as described in this disclosure. Such databases may be implemented as fault-tolerant, relational, scalable, secure databases such as Oracle or Sybase.

The operating system 1007 may facilitate resource management and operation of the computer system 1000. Examples of operating systems include, without limitation, Apple Macintosh OS X, Unix, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like. User interface 417 may facilitate display, execution, interaction, manipulation, or operation of program components through textual or graphical facilities. For example, user interfaces may provide computer interaction interface elements on a display system operatively connected to the computer system 1000, such as cursors, icons, check boxes, menus, scrollers, windows, widgets, etc. Graphical user interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

In some embodiments, the computer system 1000 may implement a web browser 1008 stored program component. The web browser may be a hypertext viewing application, such as Microsoft Internet Explorer, Google Chrome, Mozilla Firefox, Apple Safari, etc. Secure web browsing may be provided using HTTPS (secure hypertext transport protocol), secure sockets layer (SSL), Transport Layer Security (TLS), etc. Web browsers may utilize facilities such as AJAX, DHTML, Adobe Flash, JavaScript, Java, application programming interfaces (APIs), etc. In some embodiments, the computer system 401 may implement a mail server 419 stored program component. The mail server may be an Internet mail server such as Microsoft Exchange, or the like. The mail server may utilize facilities such as ASP, ActiveX, ANSI C++/C#, Microsoft .NET, CGI scripts, Java, JavaScript, PERL, PHP, Python, WebObjects, etc. The mail server may utilize communication protocols such as internet message access protocol (IMAP), messaging application programming interface (MAPI), Microsoft Exchange, post office protocol (POP), simple mail transfer protocol (SMTP), or the like. In some embodiments, the computer system 400 may implement a mail client stored program component. The mail client may be a mail viewing application, such as Apple Mail, Microsoft Entourage, Microsoft Outlook, Mozilla Thunderbird, etc.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

In one implementation, each of the one or more user devices 301 may include an input/output (I/O) interface for communicating with input/output (I/O) devices (not shown in FIG. 10). The result summarizing apparatus 201 may include an input/output (I/O) interface for communicating with the query executor 302, the group generating unit 314 and the one or more user devices 301. The one or more user devices 301 are installed with one or more interfaces (not shown in FIG. 10) for communicating with the query executor 302 over a first network (not shown in FIG. 10) and the result summarizing apparatus 201 over the fourth network (not shown). Further, the one or more interfaces 1004 in the result summarizing apparatus 201 are used to communicate with the query executor 302 over the second network (not shown in FIG. 10) and the group generating unit 314 over the third network (not shown). The one or more interfaces of the result summarizing apparatus 201 may include software and/or hardware to support one or more communication links (not shown) for communication. In an embodiment, the one or more user devices 201 communicate with the first network, the second network, the third network an the fourth network via a network interface (not shown in FIG. 10). The network interface may employ connection protocols include, but not limited to, direct connect, Ethernet (e.g., twisted pair 10/100/1000 Base T), transmission control protocol/internet protocol (TCP/IP), token ring, IEEE 802.11a/b/g/n/x, etc.

Each of the first network, the second network, the third network and the fourth network includes, but is not limited to, a direct interconnection, an e-commerce network, a peer to peer (P2P) network, local area network (LAN), wide area network (WAN), wireless network (e.g., using Wireless Application Protocol), the Internet, Wi-Fi and such. The first network and the second network may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the first network and the second network may include a variety of network devices, including routers, bridges, servers, computing devices, storage devices, etc.

Additionally, advantages of present disclosure are illustrated herein.

Embodiments of the present disclosure provide faster analysis over data store by using the one or more summary reports options. The present disclosure fine tunes the query analysis by using the one or more summary reports options and enhances the productivity of the end users. Further, the present disclosure reduces the time for analyzing the query results for the one or more queries. Furthermore, the present disclosure provides the summary reports options which are not restrict to OLAP reports options only as disclosed in one of the prior arts. Particularly, the summary reports options comprise all kinds of reports related to big data.

The described operations may be implemented as a method, system or article of manufacture using standard programming and/or engineering techniques to produce software, firmware, hardware, or any combination thereof. The described operations may be implemented as code maintained in a “non-transitory computer readable medium”, where a processor may read and execute the code from the computer readable medium. The processor is at least one of a microprocessor and a processor capable of processing and executing the queries. A non-transitory computer readable medium may comprise media such as magnetic storage medium (e.g., hard disk drives, floppy disks, tape, etc.), optical storage (CD-ROMs, DVDs, optical disks, etc.), volatile and non-volatile memory devices (e.g., EEPROMs, ROMs, PROMs, RAMs, DRAMs, SRAMs, Flash Memory, firmware, programmable logic, etc.), etc. Further, non-transitory computer-readable media comprise all computer-readable media except for a transitory. The code implementing the described operations may further be implemented in hardware logic (e.g., an integrated circuit chip, Programmable Gate Array (PGA), Application Specific Integrated Circuit (ASIC), etc.).

Still further, the code implementing the described operations may be implemented in “transmission signals”, where transmission signals may propagate through space or through a transmission media, such as an optical fiber, copper wire, etc. The transmission signals in which the code or logic is encoded may further comprise a wireless signal, satellite transmission, radio waves, infrared signals, Bluetooth, etc. The transmission signals in which the code or logic is encoded is capable of being transmitted by a transmitting station and received by a receiving station, where the code or logic encoded in the transmission signal may be decoded and stored in hardware or a non-transitory computer readable medium at the receiving and transmitting stations or devices. An “article of manufacture” comprises non-transitory computer readable medium, hardware logic, and/or transmission signals in which code may be implemented. A device in which the code implementing the described embodiments of operations is encoded may comprise a computer readable medium or hardware logic. Of course, those skilled in the art will recognize that many modifications may be made to this configuration without departing from the scope of the disclosure, and that the article of manufacture may comprise suitable information bearing medium known in the art.

The terms “an embodiment”, “embodiment”, “embodiments”, “the embodiment”, “the embodiments”, “one or more embodiments”, “some embodiments”, and “one embodiment” mean “one or more (but not all) embodiments of the disclosure(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

A description of an embodiment with several components in communication with each other does not imply that all such components are required. On the contrary a variety of optional components are described to illustrate the wide variety of possible embodiments of the disclosure.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the disclosure need not include the device itself.

The illustrated operations of FIGS. 8 (a and b), and 9 show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

Finally, the language used in the specification has been principally selected for readability and instructional purposes, and it may not have been selected to delineate or circumscribe the inventive subject matter. It is therefore intended that the scope of the disclosure be limited not by this detailed description, but rather by any claims that issue on an application based here on. Accordingly, the embodiments of the present disclosure are intended to be illustrative, but not limiting, of the scope of the disclosure, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

What is claimed is:

1. A method for providing summary reports options on query results, the method comprising:
receiving, by a result summarizing apparatus, query results of one or more queries from a query executor;
receiving, by the result summarizing apparatus, one or more group information for each of one or more fields of the query results from a group generating unit, wherein the one or more group information comprises data records of each of the one or more fields grouped into one or more groups, and each of the one or more groups comprises the group record entries;
generating, by the result summarizing apparatus, one or more summary reports options on the query results using the one or more group information; and
providing, by the result summarizing apparatus, the one or more summary reports options on the query results to one or more user devices.

2. The method as claimed in claim 1 further comprising:
receiving selection of at least one summary reports option among the one or more summary reports options from the one or more user devices;
receiving selection of at least one of a group record entry among group record entries of the corresponding summary reports option from the one or more user devices;
generating one or more subsequent summary reports option of the corresponding summary reports option based on the selection of the at least one group record entry; and
providing the one or more subsequent summary reports options to the one or more user devices.

3. The method as claimed in claim 1, wherein the one or more group information is generated based on one or more parameters selected from at least one of result data of the query results, metadata of the one or more queries and context of the one or more queries.

4. The method as claimed in claim 3, wherein the one or more group information for each of the one or more fields of the query results is selected from at least one of user-defined group information, group information created using information of the one or more fields and group information defined dynamically by the group generating unit based on the one or more fields.

5. The method as claimed in claim 2, wherein the one or more summary reports options and the one or more subsequent summary reports options are generated based on factors selected from at least one of size of the query results, measure values of the query results, dimensions of the query results, the user-defined group information, group information created using information of the one or more fields, group information defined dynamically by the group generating unit based on the one or more fields, query results of previous queries, and size of a user interface of the one or more user devices.

6. A result summarizing apparatus for providing summary reports options on query results, comprising:
a receiving module configured to:
receive the query results of one or more queries from a query executor;
receive one or more group information for each of one or more fields of the query results from a group generating unit, wherein the one or more group information comprises data records of each of the one or more fields grouped into one or more groups, and each of the one or more groups comprises the group record entries;
a summarizing module configured to generate one or more summary reports options on the query results using the one or more group information; and
an output module configured to provide the one or more summary reports options on the query results to one or more user devices.

7. The result summarizing apparatus as claimed in claim 6, wherein the summarizing module is further configured to provide subsequent summary reports options by performing:
receive selection of at least one summary reports option among the one or more summary reports options from the one or more user devices;
receive selection of at least one of a group record entry among the group record entries of the corresponding summary reports option from the one or more user devices;
generate one or more subsequent summary reports options of the corresponding summary reports option based on the selection of the at least one group record entry; and
provide the one or more subsequent summary reports options to the one or more user devices.

8. The result summarizing apparatus as claimed in claim 6, wherein the one or more group information is generated based on one or more parameters selected from at least one of result data of the query results, metadata of the one or more queries and context of the one or more queries.

9. The result summarizing apparatus as claimed in claim 8, wherein the one or more group information for each of the one or more fields of the query results is selected from at least one of user-defined group information, group information created using information of the one or more fields and group information defined dynamically by the group generating unit based on the one or more fields.

10. The result summarizing apparatus as claimed in claim 7, wherein the summarizing module generates the one or more summary reports options and the one or more subsequent summary reports options based on factors selected from at least one of size of the query results, measure values of the query results, dimensions of the query results, the user-defined group information, group information created using information of the one or more fields, group information defined dynamically by the group generating unit based on the one or more fields, query results of previous queries, the user raising the one or more queries and size of a user interface of the one or more user devices.

11. A non-transitory computer readable medium including operations stored thereon that when processed by at least one processing unit cause a result summarizing apparatus to perform one or more actions by performing the acts of:
receiving query results of one or more queries from a query executor;
receiving one or more group information for each of one or more fields of the query results from a group generating unit, wherein the one or more group information comprises data records of each of the one or more fields grouped into one or more groups, and each of the one or more groups comprises the group record entries;
generating one or more summary reports options on the query results using the one or more group information; and
providing the one or more summary reports options on the query results to one or more user devices.
